(19) United States
(12) Patent Application Publication
(10) Pub. No.: US 2020/0147618 A1
(43) Pub. Date: May 14, 2020

(54) Small waste material processing device

(71) Applicant: Tianya Lou, Quzhou City (CN)

(72) Inventor: Tianya Lou, Quzhou City (CN)

(21) Appl. No.: 16/732,360

(22) Filed: Jan. 2, 2020

(30) Foreign Application Priority Data
Oct. 11, 2019 (CN) 2019109651123

(51) Int. Cl. B02C 23/08; B30B 9/20

(52) U.S. Cl. CPC B02C 23/08; B02C 2201/063; B30B 9/20

(57) ABSTRACT

A small-scale waste processing device includes a housing, wherein a conveying cavity is provided in the housing, a screw is rotatably provided in the conveying cavity, a rotating cavity is provided in the housing, and the rotating cavity and the conveying The cavity is connected, and a rotating block is rotatably provided in the rotating cavity. A squeezing mechanism is provided in the rotating block. A first filter is fixedly arranged on the right wall of the rotating cavity. The present invention can pass kitchen wastes through Most of the water is squeezed out, and then the water in the waste is thrown out by throwing water to make the waste more dehydrated. The discharged waste water can be directly discharged to the sewer, which avoids clogging of the sewer and saves maintenance costs. The dehydrated waste passes through Grinding and squeezing makes it difficult to make full use of the packing space during the later packing process of waste materials, and at the same time avoids the leakage of waste water from the waste materials, causing pollution to the environment.

### CROSS-REFERENCES TO RELATED APPLICATIONS

The present application claims priority from Chinese application No. 2019109651123 filed on Oct. 11, 2019 which is hereby incorporated by reference in its entirety.

### FIELD OF TECHNOLOGY

The invention relates to the technical field of waste treatment, and in particular relates to a small waste material processing device.

### TECHNICAL FIELD

When processing kitchen waste, the water in the waste will penetrate the garbage bag, the smell is bad and it will also cause pollution to the environment. If the waste is directly discharged to the sewer, it will easily cause the sewer to be blocked. The later maintenance costs are high. In the process of waste materials, it is impossible to make full use of the packing space, and it is easy to fill up, which is not conducive to the subsequent garbage disposal. In order to solve the above problems, the present invention is proposed.

### CONTENT OF THE INVENTION

In view of the shortcomings of the above technology, the present invention proposes a small-scale waste processing device, which can overcome the above-mentioned defects.

The invention is a small-scale waste processing device, which includes a casing, wherein the casing is provided with a conveying cavity, the conveying cavity is rotatably provided with a screw, the casing is provided with a rotating cavity, and the rotating cavity and The conveying cavity is communicated, a rotating block is rotatably provided in the rotating cavity, a squeezing mechanism is provided in the rotating block, a first filter is fixedly arranged on the right wall of the rotating cavity, and a lower end of the first filter A filter cavity is provided, and a waste water tank is fixed at the lower end of the shell. The waste water tank is provided with a waste water cavity, the filter cavity is in communication with the waste water cavity, and a drain valve is provided in the right wall of the waste water cavity. The screw is conveyed into the rotating cavity, the rotating block rotates to squeeze the water in the waste, and the water is discharged into the filtering cavity through the first filter screen, and the water in the filtering cavity enters the wastewater Cavity to realize the preliminary drainage of waste materials;

A first water pipe is connected to the lower end of the rotation chamber, and a squeeze chamber is provided on the lower side of the first water pipe. A water-flicking mechanism is provided in the squeeze chamber. After the waste material enters the squeeze chamber, Drying is performed under the action of a water-removal mechanism. A grinding chamber is provided at the lower end of the squeeze chamber, and a grinding mechanism is provided in the grinding chamber. After the waste is dried, the waste material enters the grinding chamber and is ground in the grinding chamber. The waste material is ground under the action of a crushing mechanism. The casing is provided with a collection chamber located below the grinding chamber, and a compression mechanism is provided in the collection chamber. The crushed waste is compressed by the compression. After the mechanism is compressed, the waste material is processed.

Further, a feeding shell with an upward opening is fixed on the top end of the shell, a feeding cavity is provided in the feeding shell, a transport pipe is connected to the lower end of the feeding shell, and the transport pipe extends to the conveyance. In the cavity, a transmission cavity is provided at the left end of the conveying cavity, and the screw extends into the transmission cavity. A rotor housing is fixed at the right end of the screw, and a collection box is detachably provided at the lower end of the housing. A grinding shell is connected to the right end of the box, and a pumping plate is connected to the left end of the collection box.

Further, the pressing mechanism includes a first rotating shaft rotatably provided in the rotating cavity, a first gear is fixed on the first rotating shaft, and a second gear is fixed on the rotating block. The second gear meshes with the first gear, a scraper is fixed on the rotating block, and the second gear drives the rotating block to rotate in the rotating cavity by meshing with the first gear, thereby realizing waste Squeeze, while the scraper scrapes off the waste material adhering to the inner wall of the rotating chamber.

Further, the water throwing mechanism includes a second rotating shaft rotatably provided in the squeeze cavity, a second filter screen is fixed in the squeeze cavity, and a spring cavity is provided in the housing, so that A return spring is fixed in the spring cavity, and the other end of the return spring is fixedly connected to the second filter screen. A drain pipe is provided on the lower side of the second filter screen, and the drain pipe is in communication with the wastewater cavity.

Further, the grinding mechanism includes a third rotating shaft rotatably disposed in the grinding cavity, a third gear is fixed on the third rotating shaft, and a fourth rotating shaft is fixed on the right end of the third gear. A fourth gear is fixed on the fourth rotating shaft, and the third gear meshes with the fourth gear.

Further, the compression mechanism includes a pressing plate provided in the collecting cavity that can be moved up and down. A moving block is connected to the upper end of the pressing plate, and a driven cavity is provided at the upper end of the collecting cavity. The moving block extends to In the driven cavity, a fifth shaft is rotatably provided at the rear end of the moving block, and a fifth gear is fixed on the fifth rotating shaft, and the fifth gear meshes with the teeth in the moving block.

Further, a transmission cavity is provided in the housing, a motor is fixed on the left wall of the transmission cavity, a transmission rod is rotatably provided on the right side of the motor, and a sixth gear is fixed on the transmission rod. A seventh gear is fixed at the lower end of the sixth gear, the seventh gear meshes with the sixth gear, a first fixing block is fixed at the lower end of the seventh gear, and a first fixing block is rotatably provided in the first fixing block. Six rotating shafts, the sixth rotating shaft is fixedly connected to the seventh gear, an eighth gear is fixedly located at the lower end of the sixth rotating shaft, a ninth gear is fixedly located at the right end of the eighth gear, and the ninth gear is connected to the first gear. Eight gears mesh, a right end of the ninth gear is fixed with a second fixing block, and a seventh rotating shaft is rotatably provided in the second fixing block. The seventh rotating shaft is fixedly connected to the ninth gear and the seventh rotating shaft. A tenth gear is fixed at the right end, an eleventh gear is fixed at the lower end of the tenth gear, the eleventh gear meshes with the tenth gear, and a third fixing block is fixed at the lower end of the eleventh gear. The second fixed block is rotatably provided with a second Shaft, said second shaft fixedly connected with the eleventh gear.

Further, a twelfth gear is fixedly arranged at the rear end of the sixth gear, the twelfth gear meshes with the sixth gear, a fourth fixing block is fixedly arranged on the rear wall of the transmission cavity, and the fourth An eighth rotating shaft is rotatably provided in the fixing block, and the eighth rotating shaft is fixedly connected to the twelfth gear. A thirteenth gear is fixed at the right end of the eighth rotating shaft, and a tenth is fixed at the front end of the thirteenth gear. Four gears, the fourteenth gear meshes with the thirteenth gear, and a front end of the fourteenth gear is fixedly provided with a first rotating shaft.

Further, a fifteenth gear is fixedly provided on the left end of the tenth gear, a sixteenth gear is fixedly provided on the left end of the fifteenth gear, the sixteenth gear meshes with the fifteenth gear, and the first A fifth fixing block is fixed at the lower end of the sixteen gear, and a ninth rotating shaft is rotatably provided in the fifth fixing block. The ninth rotating shaft is fixedly connected to the sixteen gear, and a tenth is fixed on the ninth rotating shaft. Seven gears, an eighteenth gear is fixedly arranged at the front end of the seventeenth gear, the eighteenth gear is meshed with the seventeenth gear, a fifth rotating shaft is fixedly fixed at the front end of the eighteenth gear, and the first The lower end of the seventeenth gear is fixedly provided with a nineteenth gear, the right end of the nineteenth gear is fixedly provided with a twentieth gear, the twentieth gear is meshed with the nineteenth gear, and the rear wall of the driven cavity is fixed A sixth fixing block is provided. A tenth rotating shaft is rotatably provided in the sixth fixing block. The tenth rotating shaft is fixedly connected to the twentieth gear. The right end of the tenth rotating shaft is fixed with a twenty-first gear. A twenty-second gear is fixedly arranged at the front end of the twenty-first gear, Said gear-second gear engaged with the twenty-first, the twenty-second gear fixed to the front end of the third shaft is provided.

The beneficial effects of the present invention: The present invention can first discharge most of the water from the kitchen waste by squeezing, and then throw the water out of the waste by throwing water to make the waste more dehydrated. The discharged waste water can be directly discharged to the sewer. Preventing sewer blockage and saving maintenance costs. The dewatered waste is ground and squeezed, which makes it difficult to make full use of the packing space in the later waste packing process. At the same time, it prevents the waste water from seeping out and causing pollution to the environment.

### BRIEF DESCRIPTION OF THE DRAWINGS

The present invention is described in detail below with reference to FIGS. 1-6. For convenience of description, the orientation described below is defined as follows: the up-down, left-right, front-back direction described below is consistent with the up-down, left-right, front-back direction of the projection relationship of the figure itself.

FIG. 1 is a schematic diagram of the overall structure of a small-scale waste processing device according to the present invention; FIG.

FIG. 2 is a schematic structural diagram at A-A in FIG. 1;

FIG. 3 is a schematic structural diagram at B-B in FIG. 1;

FIG. 4 is a schematic structural diagram at C-C in FIG. 1;

FIG. 5 is a schematic structural diagram at D in FIG. 1;

FIG. 6 is a schematic structural diagram at E in FIG. 1.

### DETAILED DESCRIPTION OF THE INVENTION

The present invention is further described below with reference to the description of the drawings and embodiments. The manner of the present invention includes but is not limited to the following embodiments.

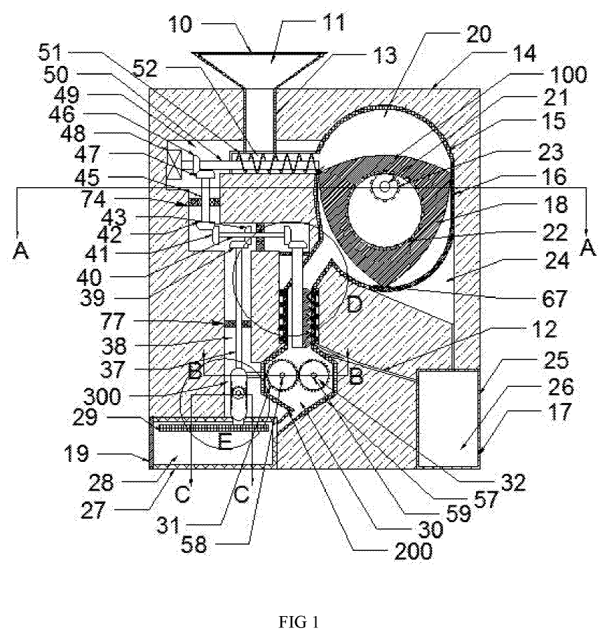

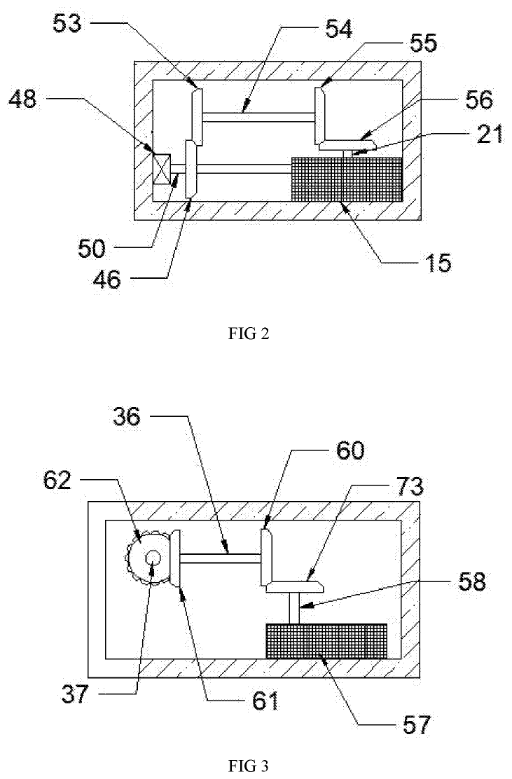

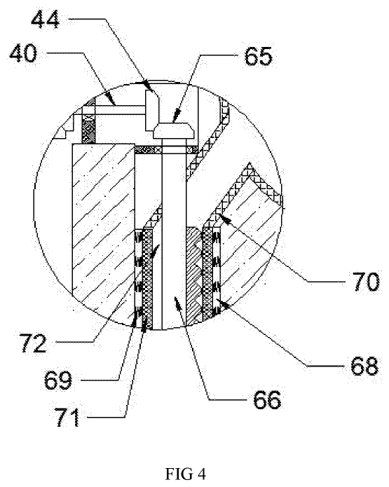

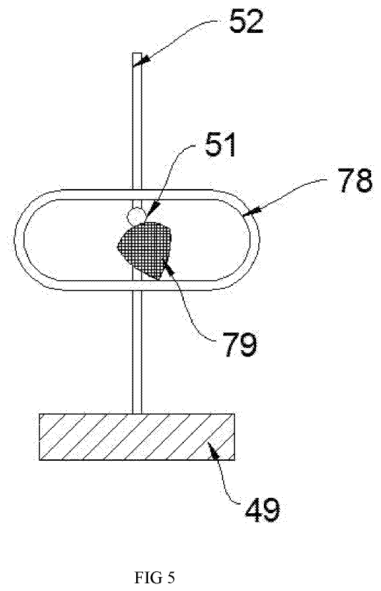

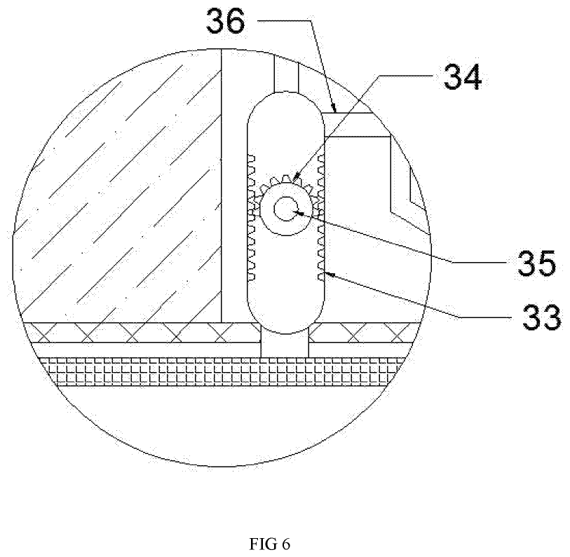

As shown in FIGS. 1-6, a small-scale waste processing device includes a casing 14 in which a conveying cavity 52 is provided, and a screw 51 is rotatably provided in the conveying cavity 52. The casing 14 A rotating cavity 20 is provided therein, and the rotating cavity 20 is in communication with the conveying cavity 52. The rotating cavity 20 is rotatably provided with a rotating block 18, and the rotating block 18 is provided with a pressing mechanism 100. A first filter screen 16 is fixed on the right wall of the cavity 20, a filter cavity 24 is provided at the lower end of the first filter screen 16, a waste water tank 25 is fixed at the lower end of the casing 14, and a waste water cavity is provided in the waste water tank 25 26. The filter chamber 24 is in communication with the waste water chamber 26. A drain valve 17 is provided in the right wall of the waste water chamber 26. The waste material is conveyed into the rotation chamber 20 through the screw 51. The rotation block 18 rotates the waste material in the waste material chamber 26. Water is squeezed, and the water is discharged into the filter cavity 24 through the first filter screen 16, and the water in the filter cavity 24 enters the waste water cavity 26 to realize the treatment of preliminary drainage of waste materials;

A first water pipe 70 is connected to the lower end of the rotating chamber 20, and a squeeze chamber 72 is provided on the lower side of the first water pipe 70. A water-flicking mechanism 400 is provided in the squeeze chamber 72, and waste material enters the squeeze chamber. After 72, drying is performed under the action of the water-removing mechanism 400. A grinding chamber 30 is provided at the lower end of the squeeze chamber 72, and a grinding mechanism 200 is provided in the grinding chamber 30. After the waste is dried, Into the grinding chamber 30, the waste is ground under the action of the grinding mechanism 200. The casing 14 is provided with a collecting chamber 28 located below the grinding chamber 30. The collection chamber 28 is provided with a compression mechanism 300, and the crushed waste material is compressed by the compression mechanism 300 to complete the processing of the waste material.

Beneficially, a feeding housing 10 with an upward opening is fixed on the top end of the housing 14, a feeding cavity 11 is provided in the feeding housing 10, and a transport pipe 13 is connected to the lower end of the feeding housing 10, and the transportation The tube 13 extends into the conveying cavity 52, a transmission cavity 49 is provided at the left end of the conveying cavity 52, the screw 51 extends into the transmission cavity 49, and a rotor housing 15 is fixedly located at the right end of the screw 51. A collection box 27 is detachably provided at the lower end of the casing 14, a grinding case 57 is connected to the right end of the collection box 27, and a drawing plate 19 is connected to the left end of the collection box 27.

Beneficially, the pressing mechanism 100 includes a first rotating shaft 21 rotatably disposed in the rotating cavity 20, a first gear 23 is fixedly mounted on the first rotating shaft 21, and a rotating gear 18 is fixedly provided in the rotating block 18. There is a second gear 22, the second gear 22 meshes with the first gear 23, a scraper 67 is fixed on the rotating block 18, and the second gear 22 is driven by meshing with the first gear 23 The rotating block 18 rotates in the rotating cavity 20 so as to squeeze the waste material. At the same time, the scraper 67 scrapes the waste material adhered to the inner wall of the rotating cavity 20.

Beneficially, the water throwing mechanism 400 includes a second rotating shaft 66 rotatably disposed in the squeeze cavity 72, and a second filter 71 is fixed in the squeeze cavity 72. A spring cavity 68 is provided, and a return spring 69 is fixed in the spring cavity 68. The other end of the return spring 69 is fixedly connected to the second filter 71, and a drain pipe is provided on the lower side of the second filter 71. 12. The drain pipe 12 is in communication with the waste water chamber 26.

Beneficially, the grinding mechanism 200 includes a third rotating shaft 58 rotatably disposed in the grinding cavity 30. A third gear 31 is fixed on the third rotating shaft 58 and a right end of the third gear 31 A fourth rotating shaft 59 is fixedly provided, a fourth gear 32 is fixedly fixed on the fourth rotating shaft 59, and the third gear 31 meshes with the fourth gear 32.

Beneficially, the compression mechanism 300 includes a pressure plate 29 provided in the collection cavity 28 that can move up and down. A moving block 33 is connected to the upper end of the pressure plate 29, and a driven cavity 38 is provided on the upper end of the collection cavity 28. The moving block 33 extends into the driven cavity 38. A fifth rotating shaft 35 is rotatably provided at the rear end of the moving block 33. A fifth gear 34 is fixed on the fifth rotating shaft 35, and the fifth The gear 34 meshes with a tooth in the moving block 33.

Beneficially, a transmission cavity 49 is provided in the casing 14, and a motor 48 is fixed on the left wall of the transmission cavity 49. A transmission rod 50 is rotatably provided on the right side of the motor 48. There is a sixth gear 46, a seventh gear 47 is fixed at the lower end of the sixth gear 46, the seventh gear 47 is meshed with the sixth gear 46, and a first fixing block is fixed at the lower end of the seventh gear 47 74. A sixth rotating shaft 45 is rotatably provided in the first fixing block 74, the sixth rotating shaft 45 is fixedly connected to the seventh gear 47, and an eighth gear 42 is fixed at the lower end of the sixth rotating shaft 45. A right end of the eighth gear 42 is fixedly provided with a ninth gear 41, the ninth gear 41 is meshed with the eighth gear 42, and a right end of the ninth gear 41 is fixedly provided with a second fixing block 75, the second fixing block A seventh rotating shaft 40 is rotatably provided in 75, and the seventh rotating shaft 40 is fixedly connected to the ninth gear 41. A tenth gear 44 is fixed at the right end of the seventh rotating shaft 40, and a lower end of the tenth gear 44 is fixed. An eleventh gear 65 that meshes with the tenth gear 44 and a lower end of the eleventh gear 65 is fixed The third fixing block 76 is provided, within the third fixing block 76 may be provided with a second rotatable shaft 66, the second shaft 66 and the eleventh gear 65 is fixedly connected.

Beneficially, a twelfth gear 53 is fixed at the rear end of the sixth gear 46, the twelfth gear 53 meshes with the sixth gear 46, and a fourth fixing block is fixed at the rear wall of the 49 transmission cavity. 78. An eighth rotating shaft 54 is rotatably provided in the fourth fixing block 78. The eighth rotating shaft 54 is fixedly connected to the twelfth gear 53. A thirteenth gear 55 is fixed at the right end of the eighth rotating shaft 54. A fourteenth gear 56 is fixed at the front end of the thirteenth gear 55, the fourteenth gear 56 is meshed with the thirteenth gear 55, and a first rotation shaft 21 is fixed at the front end of the fourteenth gear 56.

Beneficially, a fifteenth gear 43 is fixed at the left end of the tenth gear 44, and a sixteenth gear 39 is fixed at the left end of the fifteenth gear 43. The sixteenth gear 39 and the fifteenth gear are fixed. 43 mesh, a fifth fixing block 77 is fixedly arranged at the lower end of the sixteenth gear 39, and a ninth rotating shaft 37 is rotatably provided in the fifth fixing block 77, and the ninth rotating shaft 37 is fixedly connected to the sixteen gear 39 A seventeenth gear 64 is fixed on the ninth rotating shaft 37, and an eighteenth gear 63 is fixed on the front end of the seventeenth gear 64. The eighteenth gear 63 meshes with the seventeenth gear 64 A fifth rotation shaft 35 is fixed at the front end of the eighteenth gear 63, a nineteenth gear 62 is fixed at the lower end of the seventeenth gear 64, and a twentieth gear 61 is fixed at the right end of the nineteenth gear 62 The twentieth gear 61 is meshed with the nineteenth gear 62. A sixth fixing block 79 is fixed on the rear wall of the driven cavity 38, and a tenth rotating shaft is rotatably provided in the sixth fixing block 79. 36. The tenth rotation shaft 36 is fixedly connected to the twentieth gear 61, and the right end of the tenth rotation shaft 36 is fixedly provided with a twenty-first gear 60 A twenty-second gear 73 is fixed at the front end of the twenty-first gear 60, the twenty-second gear 73 is meshed with the twenty-first gear 60, and a front end of the twenty-second gear 73 is fixed Third shaft 58.

A method for implementing a small-scale waste processing device as described in the following steps:

In the initial state of the present invention, the return spring 69 is not elastically deformed;

1. Put the waste material into the feeding chamber 11, start the motor 48, the motor 48 drives the transmission rod 50 to rotate, and transport the waste material into the rotation chamber 20;

2. The transmission lever 50 drives the sixth gear 46 to rotate, the sixth gear 46 drives the twelfth gear 53 to rotate, the twelfth gear 53 drives the eighth rotating shaft 54 to rotate, the eighth rotating shaft 54 drives the thirteenth gear 55 to rotate, tenth The three gears 55 drive the fourteenth gear 56 to rotate, the fourteenth gear 56 drives the first rotating shaft 21 to rotate, the first rotating shaft 21 drives the first gear 23 to rotate, the first gear 23 drives the second gear 22 to rotate, and the second gear 22 drives The rotation block 18 rotates;

3. When the waste material reaches the position of the first filter screen 16, the space becomes smaller to squeeze the waste material, and the water in the waste material is discharged into the waste water cavity 26;

4. The sixth gear 46 drives the seventh gear 47 to rotate, the seventh gear 47 drives the sixth shaft 45 to rotate, the sixth shaft 45 drives the eighth gear 42 to rotate, the eighth gear 42 drives the ninth gear 41 to rotate, and the ninth gear 41 Drive the seventh rotating shaft 40 to rotate, the seventh rotating shaft 40 to drive the tenth gear 44 to rotate, the tenth gear 44 to drive the eleventh gear 65 to rotate, and the eleventh gear 65 to drive the second rotating shaft 66 to rotate;

5. The waste material enters the squeeze cavity 72 through the first water pipe 70, and the second rotating shaft 66 drives the waste material to squeeze the second filter screen 71, and realizes spin-drying under the action of the reset spring 69;

6. The seventh rotating shaft 40 drives the fifteenth gear 43 to rotate, the fifteenth gear 43 drives the sixteenth gear 39 to rotate, the sixteenth gear 39 drives the ninth rotating shaft 37 to rotate, and the ninth rotating shaft 37 drives the nineteenth gear 62 to rotate The nineteenth gear 62 drives the twentieth gear 61 to rotate, the twentieth gear 61 drives the tenth rotation shaft 36 to rotate, the tenth rotation shaft 36 drives the twenty-first gear 60 to rotate, and the twenty-first gear 60 drives the twenty-second The gear 73 rotates, the 22nd gear 73 drives the third rotating shaft 58 to rotate, the third rotating shaft 58 drives the third gear 31 to rotate, the third gear 31 drives the fourth gear 32 to rotate, and the waste material enters the grinding cavity from the extrusion cavity 72 In 30, the waste is ground under the meshing of the two gears of the third gear 31 and the fourth gear 32;

7. The ninth rotating shaft 37 drives the seventeenth gear 64 to rotate, the seventeenth gear 64 drives the eighteenth gear 63 to rotate, the eighteenth gear 63 drives the fifth rotating shaft 35 to rotate, and the fifth rotating shaft 35 drives the fifth gear 34 to rotate, The fifth gear 34 drives the moving block 33 to move up and down, thereby driving the pressure plate 29 to beat up and down, thereby compressing the waste material.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A small-scale waste processing device includes a housing, wherein the housing is provided with a conveying cavity, the conveying cavity is rotatably provided with a screw, the housing is provided with a rotating cavity, and the rotating cavity In communication with the conveying cavity, a rotating block is rotatably provided in the rotating cavity, a squeezing mechanism is provided in the rotating block, and a first filter screen is fixedly arranged on the right wall of the rotating chamber. A filter cavity is provided at the lower end, and a waste water tank is fixed at the lower end of the housing. The waste water tank is provided with a waste water cavity, the filter cavity is in communication with the waste water cavity, and a drain valve is provided in the right wall of the waste water cavity. The waste material is conveyed into the rotating cavity through the screw, and the rotating block rotates to squeeze the water in the waste material, the water is discharged into the filtering cavity through the first filter screen, and the water in the filtering cavity enters the In the waste water cavity, realize the preliminary drainage treatment of waste materials; a first water pipe is connected to the lower end of the rotation chamber, and a squeeze chamber is provided on the lower side of the first water pipe. A water-flicking mechanism is provided in the squeeze chamber. After the waste material enters the squeeze chamber, Drying is performed under the action of a water-removal mechanism. A grinding chamber is provided at the lower end of the squeeze chamber, and a grinding mechanism is provided in the grinding chamber. After the waste is dried, the waste material enters the grinding chamber and is ground in the grinding chamber. The waste material is ground under the action of a crushing mechanism. The casing is provided with a collection chamber located below the grinding chamber, and a compression mechanism is provided in the collection chamber. The crushed waste is compressed by the compression. After the mechanism is compressed, the waste material is processed.

2. The small-scale waste processing device according to claim 1, characterized in that: a feeding shell with an upward opening is fixed on the top end of the shell, a feeding cavity is provided in the feeding shell, and a lower end of the feeding shell A transport pipe is connected to the transport pipe, the transport pipe extends into the transport chamber, a transmission chamber is provided at the left end of the transport chamber, the screw extends into the transmission chamber, and a rotor housing is fixed at the right end of the screw. A collection box is detachably provided at the lower end of the housing, a grinding housing is connected to the right end of the collection box, and a drawing board is connected to the left end of the collection box.

3. The small-scale waste processing device according to claim 2, wherein the pressing mechanism includes a first rotating shaft rotatably disposed in the rotating cavity, and a first rotating shaft is fixedly disposed on the first rotating shaft. A gear, a second gear is fixed in the rotating block, the second gear is meshed with the first gear, a scraper is fixed on the rotating block, and the second gear passes through the first gear The meshing drives the rotating block to rotate in the rotating cavity, so as to squeeze the waste material. At the same time, the scraper scrapes the waste material adhered to the inner wall of the rotating cavity.

4. The small-scale waste processing device according to claim 3, wherein the water throwing mechanism comprises a second rotating shaft rotatably disposed in the squeeze cavity, and the squeeze cavity is fixedly provided with a first Two filters, the housing is provided with a spring cavity, a return spring is fixed in the spring cavity, the other end of the return spring is fixedly connected to the second filter, and a lower side of the second filter is provided There is a drain pipe which is in communication with the waste water cavity.

5. The small-scale waste processing device according to claim 4, wherein the grinding mechanism comprises a third rotating shaft rotatably disposed in the grinding cavity, and the third rotating shaft is fixedly provided with a first rotating shaft Three gears, a fourth rotating shaft is fixedly arranged on the right end of the third gear, a fourth gear is fixedly fixed on the fourth rotating shaft, and the third gear meshes with the fourth gear.

6. The small-scale waste processing device according to claim 5, wherein the compression mechanism comprises a pressure plate which is arranged in the collection chamber and can move up and down, and a moving block is connected to the upper end of the pressure plate, and the collection device The upper end of the cavity is provided with a driven cavity, and the moving block extends into the driven cavity. A rear end of the moving block is rotatably provided with a fifth rotating shaft, and a fifth gear is fixed on the fifth rotating shaft. The fifth gear meshes with teeth in the moving block.

7. The small-scale waste processing device according to claim 6, characterized in that: a driving cavity is provided in the casing, a motor is fixed on the left wall of the driving cavity, and a driving rod is rotatably provided on the right side of the motor. A sixth gear is fixed on the transmission lever, a seventh gear is fixed on the lower end of the sixth gear, the seventh gear meshes with the sixth gear, and a first is fixed on the lower end of the seventh gear. A fixing block, a sixth rotating shaft is rotatably provided in the first fixing block, the sixth rotating shaft is fixedly connected to the seventh gear, an eighth gear is fixedly installed at the lower end of the sixth rotating shaft, and the right end of the eighth gear is fixed A ninth gear is provided, the ninth gear meshes with the eighth gear, a right end of the ninth gear is fixed with a second fixing block, and a seventh rotating shaft is rotatably provided in the second fixing block. A seventh rotating shaft is fixedly connected to the ninth gear, a tenth gear is fixedly located at the right end of the seventh rotating shaft, an eleventh gear is fixedly fixed at the lower end of the tenth gear, and the eleventh gear meshes with the tenth gear. The lower end of the eleventh gear is fixedly provided A third fixing block, a second rotating shaft is rotatably provided in the third fixing block, and the second rotating shaft is fixedly connected to the eleventh gear.

8. The small-scale waste disposal device according to claim 1, wherein a twelfth gear is fixedly arranged at the rear end of the sixth gear, the twelfth gear meshes with the sixth gear, and the transmission A fourth fixing block is fixed on the back wall of the cavity. The fourth fixing block is rotatably provided with an eighth rotating shaft, the eighth rotating shaft is fixedly connected to the twelfth gear, and the right end of the eighth rotating shaft is fixedly provided with a tenth Three gears, a fourteenth gear is fixed at the front end of the thirteenth gear, the fourteenth gear is meshed with the thirteenth gear, and a first rotating shaft is fixed at the front end of the fourteenth gear.

9. The small-scale waste treatment device according to claim 1, wherein a fifteenth gear is fixedly provided on the left end of the tenth gear, and a sixteenth gear is fixedly provided on the left end of the fifteenth gear, and the first A sixteenth gear meshes with the fifteenth gear, a fifth fixing block is fixedly arranged at the lower end of the sixteenth gear, and a ninth rotating shaft is rotatably provided in the fifth fixing block. Gears are fixedly connected, a seventeenth gear is fixed on the ninth rotating shaft, an eighteenth gear is fixed on the front end of the seventeenth gear, the eighteenth gear meshes with the seventeenth gear, the A fifth rotation shaft is fixed at the front end of the eighteenth gear, a nineteenth gear is fixed at the lower end of the seventeenth gear, and a twentieth gear is fixed at the right end of the nineteenth gear. The nineteenth gear is meshed, a sixth fixing block is fixed on the rear wall of the driven cavity, and a tenth rotating shaft is rotatably provided in the sixth fixing block. The tenth rotating shaft is fixedly connected to the twentieth gear. A twenty-first gear is fixedly arranged at the right end of the tenth rotating shaft, A twenty-second gear is fixed at the front end of the twenty-first gear, the twenty-second gear is meshed with the twenty-first gear, and a third rotating shaft is fixed at the front end of the twenty-second gear.
